(19) United States
(12) Patent Application Publication
(10) Pub. No.: US 2016/0255918 A1
(43) Pub. Date: Sep. 8, 2016

(54) Carabiner Key Ring

(71) Applicant: Peter Anthony Grossman, Sydney (AU)

(72) Inventor: Peter Anthony Grossman, Sydney (AU)

(21) Appl. No.: 15/055,536

(22) Filed: Feb. 27, 2016

(30) Foreign Application Priority Data
Mar. 5, 2015 (AU) 2015900769

(51) Int. Cl. A44B 15/00; F16B 45/02

(52) U.S. Cl. CPC A44B 15/00; F16B 45/02

(57) ABSTRACT

The present invention relates to a key ring or key chain having the actions of a carabiner while securely retaining keys and other attached objects.

### FIELD OF THE INVENTION

This invention relates generally to a key ring or key chain for holding keys, key rings or other objects and more specifically to a double gated key ring that can be easily attached and hung from a person's clothing, bag, chain, hook or any other suitable article while securing keys and other objects retained on the device.

### BACKGROUND OF THE INVENTION

Any discussion of the prior art throughout the specification should in no way be considered as an admission that such prior art is widely known or forms part of the common general knowledge in the field.

In general, key rings are used as a secure way to hold keys and are designed and constructed to prevent a key from detaching without the assistance of a person. Many key ring designs have achieved this goal, but in a manner that makes it difficult and inconvenient to attach or remove keys from the key ring. Typically a key chain includes a key ring, which is a ring for retaining or keeping keys together (such as a circular key ring).

Keys, and other objects that would be desirable to be carried for everyday use, have as part of their construction and shape a hole designed to allow the object to be directly fitted onto a key ring.

A carabiner is a device typically used for mountaineering and allows for a secure and relatively easy and quick attachment and/or release with another article or object. A typical carabiner forms a ring shape and has a rigid section (e.g. frame) and a moveable portion (e.g. gate) that interlock together to form the ring shape which continuously encloses an inner region in the closed position.

Over time, carabiners have become integrated into everyday use as a convenient method of holding key rings, various tools and other objects, due to the ease and speed with which objects can be attached and removed from the device coupled with the additional function of being quickly and easily attached to or detached from a person's belt loop or a bag strap, or other article thus providing a convenient way to carry numerous objects. A carabiner/key ring arrangement typically includes a key ring coupled to a carabiner as the cross sectional dimensions of the frame of a carabiner necessary to ensure the integrity of the closure system is too large to allow a standard key to be fitted directly on to the carabiner frame. In a carabiner/keychain arrangement, the keys and other objects are firstly attached to a key ring, and then the carabiner is attached to the key ring by first moving the gate to an open position allowing the carabiner frame to be fitted into the middle of the key ring, and then closing the gate, which is typically self-closing through the incorporation of a spring in the gate and hinge assembly.

It would be advantageous to provide a key ring with the actions of a carabiner that would allow easy and fast attachment and release of keys and other objects designed to be carried on a key ring. It would be advantageous to provide a key ring that would be able to attach to loops on clothing and other articles while securely retaining attached keys and other desired objects.

It would be desirable to provide a key ring that provides any or more of these and other advantageous features.

It is an object of the preferred embodiment of the present invention to overcome or ameliorate at least one of the disadvantages of the prior art, or to provide a useful alternative.

Throughout the specification and claims which follow, unless the context requires otherwise, the word “comprise”, and other variations such as “comprises” and “comprising”, will be understood to imply the inclusion of a stated integer or step or group of integers or steps but not the exclusion of any other integer or step or group of integers of steps.

### SUMMARY OF THE INVENTION

According to a first aspect of the present invention there is provided a key ring made from a single continuous piece of material comprising: a frame that can retain a standard key; an external gate that is formed from the frame and is movable to allow an opening to be made in the frame; an internal gate that is formed from the frame and is configured to separate the internal space formed by the frame and external gate into separated spaces and is movable to allow the separated spaces to become contiguous; and an internal gate that is shaped to allow an article fitted on the frame to pass in one direction only when the article is pressed against the gate.

The preferred embodiment of the present invention describes a key ring consisting of a frame with two gates, being one external gate and one internal gate, with all elements being integrally formed.

The preferred embodiment of the present invention describes a key ring on which a key, key ring, tool or other desired object can be quickly and easily fitted on to the frame and then be securely held.

The preferred embodiment of the present invention further relates to a key ring that can be attached to a belt loop, bag strap or other item while ensuring all attached objects remain secured.

It is understood that other aspects of the present invention will become readily apparent to those skilled in the art from the following detailed description, wherein it is shown and described only exemplary configurations.

As will be realized, the disclosure includes other and different shapes and configurations of the present invention and the various details presented throughout this disclosure are capable of modification in various other respects, all without departing from the spirit and scope of the disclosure. Accordingly, the drawings and the detailed description are to be regarded as illustrative in nature and not as restrictive.

### BRIEF DESCRIPTION OF THE DRAWINGS

A preferred embodiment of the invention will now be described, by way of example only, with reference to the accompanying drawings in which:

FIG. 1 is an illustration of the front perspective view of the invention with both gates in the closed position according to an exemplary embodiment.

FIG. 2 is an illustration of the front elevation view of the invention with both gates in the closed position.

FIG. 3 is an illustration of the front elevation view of the invention with the external gate in the open position and an exemplary article placed through the open gate on to the frame of the invention.

FIG. 4 is an illustration of the front elevation view of the invention with both gates closed and the exemplary article retained on the frame of the invention in front of the internal gate.

FIG. 5. is an illustration of the front elevation view of the invention with the external gate closed and the exemplary article moved along the frame with the internal gate open.

FIG. 6. is an illustration of the front elevation view of the invention with the external gate in a closed position and the exemplary article fitted on to the frame and positioned against the closed internal gate.

FIG. 7 is an illustration of the front elevation view of the invention with both gates closed and the article fully retained by the invention

FIG. 8 is an illustration of the front elevation view of the invention with the external gate opened and the internal gates closed and the article fully retained by the invention.

### DETAILED DESCRIPTION OF THE INVENTION

The present disclosure is described more fully hereinafter with reference to the FIGURES, in which various aspects of exemplary embodiments of a key ring are shown. The invention shown in the exemplary embodiments provides secured retention of one or more articles while retaining a carabiner function of being attachable to other articles. This disclosure, however, may be embodied in many different forms and should not be construed as limited by the various aspects of the key ring presented herein. The detailed description of the key ring is provided below so that this disclosure will be thorough and complete, and will fully convey the scope of the present disclosure to those skilled in the art.

Relative terms such as “front” and “back” and “inside” and “outside” may be used herein to describe one element's relationship to another element illustrated in the drawings. It will be understood that relative terms are intended to encompass different orientations of assembly in addition to the orientation depicted in the drawings.

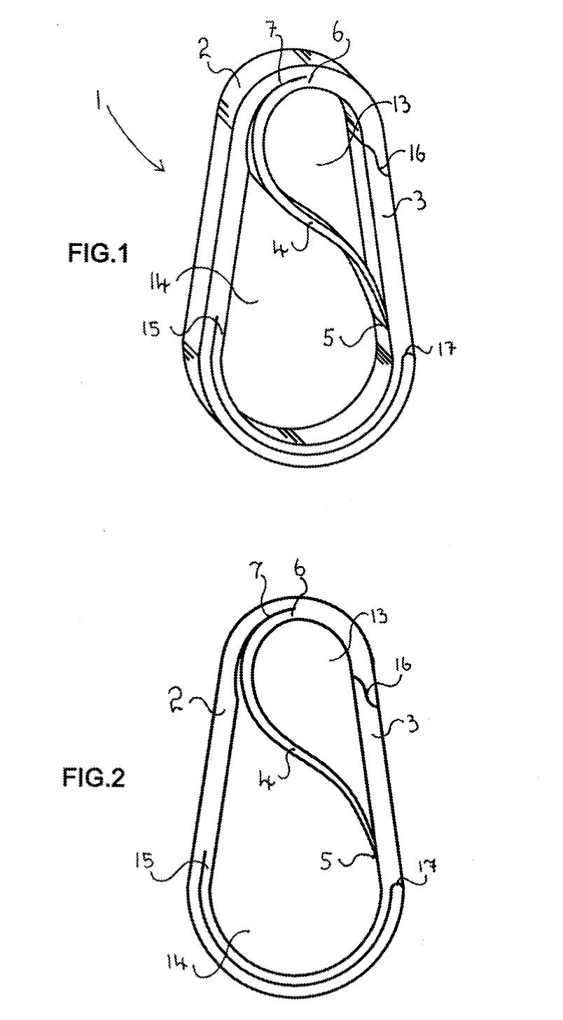

As shown in FIG. 1 the key ring 1 comprises a frame 2, an external gate 3 an internal gate 4 which are integrally formed from one piece of material and continuously enclosed inner regions 13 and 14 in the closed configuration. According to alternative embodiments the frame, the outer gate, the inner gate and the enclosed regions may have a variety of shapes and configurations and may incorporate functional elements such as, but not limited to, bottle openers.

As shown in FIG. 1 and FIG. 2 the external gate 3 extends from and is integral to the frame 2 at one end 15 but has the freedom to move while the frame remains rigid as it is separated from the frame at one end by a cut that extends through the entire thickness of the device from the front to the back between the end of the gate and the frame at location 16. The external gate is further separated from the frame by additional cuts running longitudinally along the length of the frame 17 that extend fully through the thickness of the frame to create an element that, although integral to the frame, can be moved separately from the frame. In this particularly preferred embodiment the closed position is predetermined with the external gate having a memory of this position and is biased to return to this position as a property of the materials from which the device is made, where the term “biased” means that the gate is urged toward a particular configuration and if it is forced from that configuration when released it will return to that configuration. The preferred material to fabricate the device is titanium, but any material with sufficient rigidity, strength and elasticity able to return to a predetermined position may be used including but not limited to composite materials made of various layers, metals, plastics and other compounds.

As shown in FIG. 1 and FIG. 2 the internal gate 4 extends from and is integral to the frame 2 at one end 6 but has the freedom to move while the frame remains rigid as it is separated from the frame at one end by a cut that extends through the entire thickness of the device from the front to the back between the end of the gate and the frame at location 7. The internal gate crosses the enclosed inner region and has an openable end separated from the frame by a cut that extends through the entire thickness of the device from the front to the back between the end of the gate and the frame at location 5. In this particularly preferred embodiment the internal gate 4 separates the inner region enclosed by the frame 2 and the external gate 3 into two separate regions which become a single contiguous region when the gate is pushed into its open position. The predetermined position of the internal gate is closed, with the gate biased to return to the predetermined position once any force causing it to move to an open position is removed.

The relative movements allowed between the internal gate 4, external gate 3 and the frame 2 results from the action of a living hinge resulting from the shape and thickness of the material separated from the frame to form the gates. As shown in FIG. 1 and FIG. 2 cuts extending through the entire thickness of the device from front of the device to the back of the device are made or incorporated into the structure of the device to create parts that while integrated are separated and movable from other parts of the device.

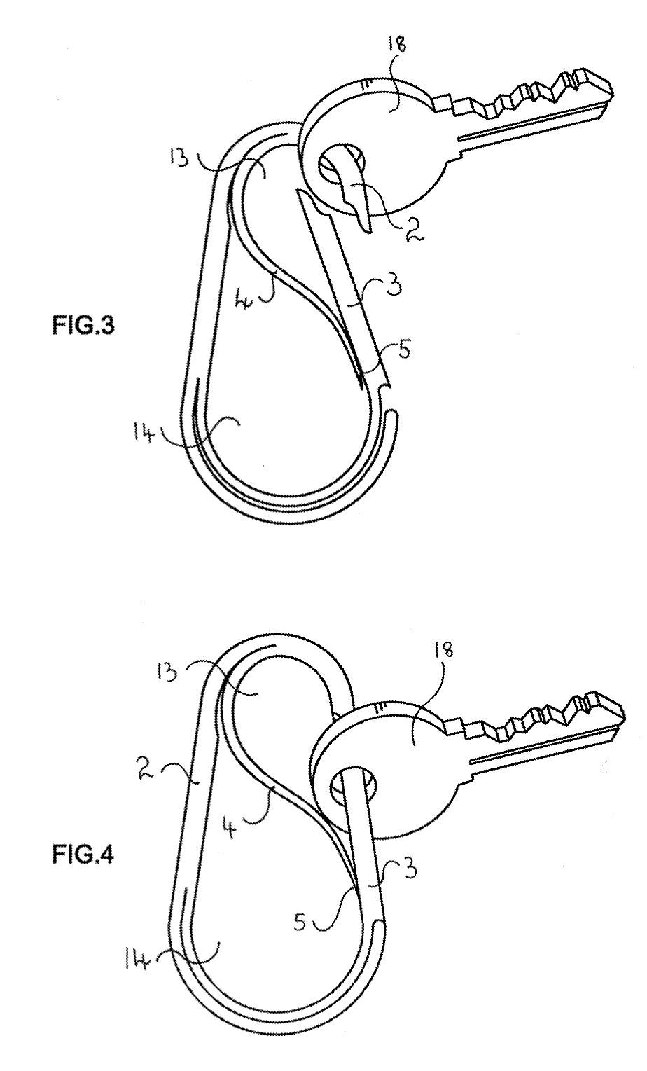

As shown in FIG. 3 an article 18, which in this particularly preferred embodiment is a standard key but which could be any object that is desired to be carried by the key ring, is fitted on to the frame after the external gate 3 has been pushed to the open position. In this embodiment the inner region 14 remains continuously enclosed whether the external gate 3 is in an open or closed position.

As shown in FIG. 4 the external gate 3 has returned to the closed position and the article 18, which in this particularly preferred embodiment is a standard key, has been moved along the frame passing over the external gate 3 towards the location 5 where the opening end of internal gate meets the frame 2.

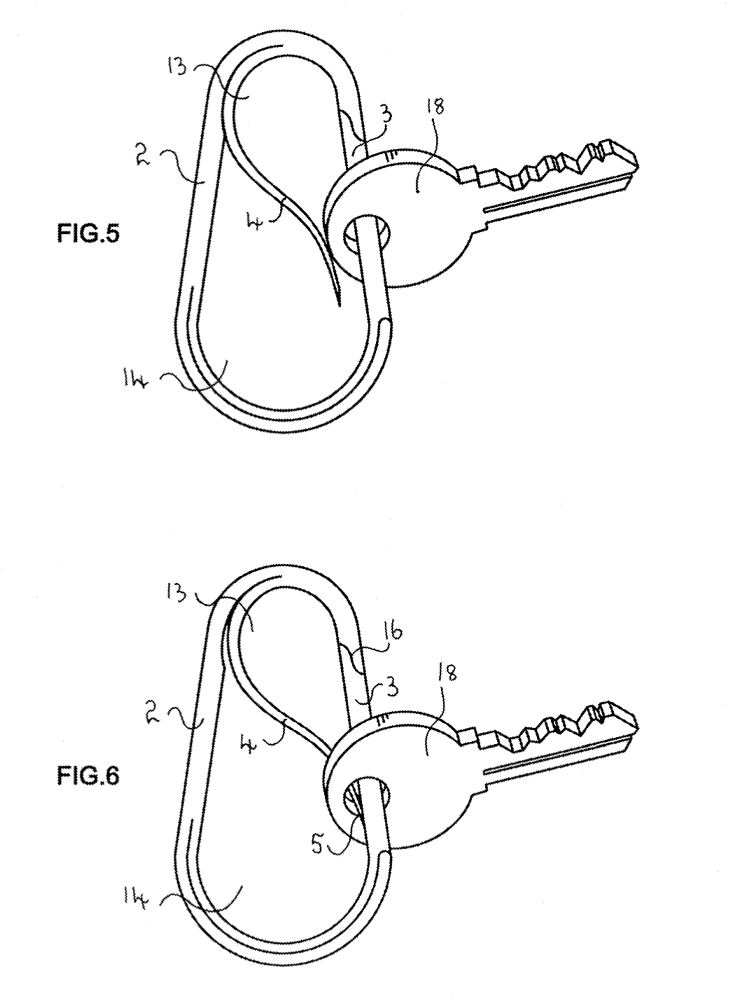

As shown in FIG. 5 the internal gate 4 has been pushed to the open position allowing the article 18 to move further along the frame 2, leaving the inner region 13 and moving to the second inner region 14. When the external gate 3 is in the closed position and the internal gate 4 is in the open position the inner regions enclosed by the frame and the external gate form one inner region. The internal gate can be pushed open by the article 18 being moved along the frame towards the inner region 14 enclosed by the frame 2 and the internal gate 4 or by force applied to the internal gate 4 typically by a finger inserted into the inner region 13.

As shown in FIG. 6 the article 18 has been moved past the internal gate 4 allowing the internal gate to return to its predetermined closed position. In this particular embodiment all gates are in the closed position and the inner regions 13 and 14 are not contiguous and are separated. The article 18 can be seen being moved back along the frame 2 towards region 13 and the external gate 3, but is being blocked from completing this movement by the shape and closed position of the internal gate 4. The article 18 will be unable to travel past the internal gate 4 and moving from the inner region 14 into the inner region 13 unless the internal gate 4 is opened by forcing it away from the frame and external gate 3 by directly applied pressure. Applying pressure to the article only will fail to cause the internal gate 4 to open, and will fail to cause the article to move past the location where the internal gate meets the frame 5. Unless the article can move along the frame past the internal gate 4 into the inner region 13 the article will not be able to be removed from the frame 2 by moving off the frame into the opening 16 made in the frame when the external gate 3 is moved to the open position as shown in FIG. 3.

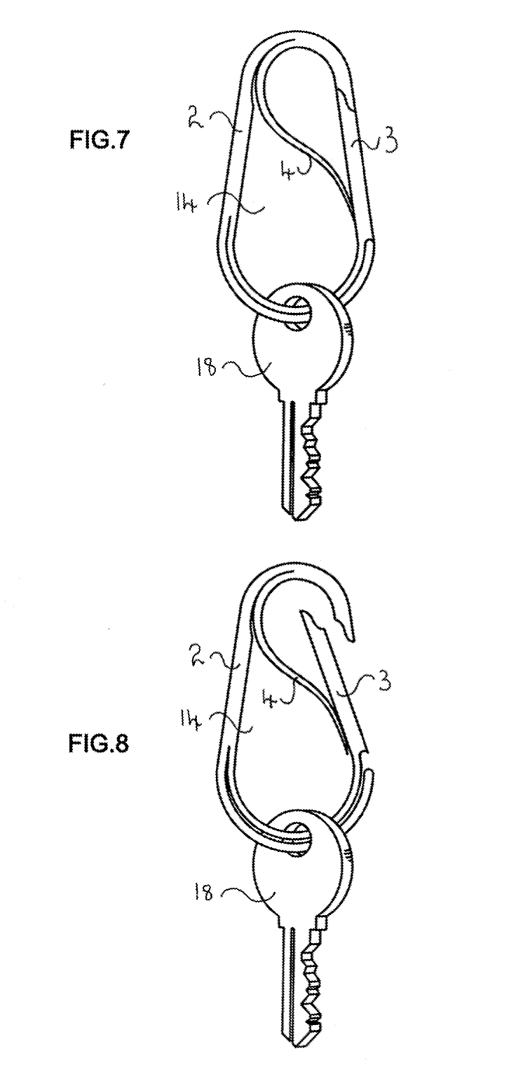

As shown in FIG. 7 the article 18 is retained securely on the frame 2 of the key ring and is securely held within the inner region 14.

As shown in FIG. 8 the article 18 remains securely retained on frame 2 of the key ring within the inner region 14 bounded by the inner gate 4 and the frame 2 even when the external gate 3 is opened to allow the key ring to be attached to another article such as a belt loop or the loop on a bag or back pack.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but is to be accorded the full scope consistent with the language claims, wherein reference to an element in the singular is not intended to mean “one and only one” unless specifically so stated, but rather one or more. All structural and functional equivalents to the elements of the various embodiments described throughout this disclosure that are known or later come to be known to those of ordinary skill in the art are expressly incorporated herein by reference and are intended to be encompassed by the claims.

1. A key ring made from a single continuous piece of material comprising:
a frame that can retain a standard key;
an external gate that is formed from the frame and is movable to allow an opening to be made in the frame;
an internal gate that is formed from the frame and is configured to separate the internal space formed by the frame and external gate into separated spaces and is movable to allow the separated spaces to become contiguous; and
an internal gate that is shaped to allow an article fitted on the frame to pass in one direction only when the article is pressed against the gate.

2. A key ring of claim 1 where the frame cannot directly retain a standard key but can retain articles with larger apertures or other key rings.

3. A key ring of claim 1 where the internal gate is movably coupled to the frame.

4. A key ring of claim 1 where the external gate is movably coupled to the frame.

5. A key ring of claim 2 where the internal gate is movably coupled to the frame.

6. A key ring of claim 2 where the external gate is movably coupled to the frame.

7. A key ring of claim 1 with the frame, the external gate and internal gate formed into various simple and complex shapes and configurations including but not limited to heart, cross, animal, geometric or any other shape that is desired.

8. A key ring of claim 2 with the frame, the external gate and internal gate formed into various simple and complex shapes and configurations including but not limited to heart, cross, animal, geometric or any other shape that is desired.

9. A key ring of claim 3 with the frame, the external gate and internal gate formed into various simple and complex shapes and configurations including but not limited to heart, cross, animal, geometric or any other shape that is desired.

10. A key ring of claim 4 with the frame, the external gate and internal gate formed into various simple and complex shapes and configurations including but not limited to heart, cross, animal, geometric or any other shape that is desired.

11. A key ring of claim 5 with the frame, the external gate and internal gate formed into various simple and complex shapes and configurations including but not limited to heart, cross, animal, geometric or any other shape that is desired.

12. A key ring of claim 6 with the frame, the external gate and internal gate formed into various simple and complex shapes and configurations including but not limited to heart, cross, animal, geometric or any other shape that is desired.

13. A key ring of claim 1 where tools and devices such as, but not limited to, bottle openers are incorporated into the shape of the frame, external gate and internal gate.

14. A key ring of claim 2 where tools and devices such as, but not limited to, bottle openers are incorporated into the shape of the frame, external gate and internal gate.

15. A key ring of claim 3 where tools and devices such as, but not limited to, bottle openers are incorporated into the shape of the frame, external gate and internal gate.

16. A key ring of claim 4 where tools and devices such as, but not limited to, bottle openers are incorporated into the shape of the frame, external gate and internal gate.

17. A key ring of claim 5 where tools and devices such as, but not limited to, bottle openers are incorporated into the shape of the frame, external gate and internal gate.

18. A key ring of claim 6 where tools and devices such as, but not limited to, bottle openers are incorporated into the shape of the frame, external gate and internal gate.
